(19) United States
(12) Patent Application Publication
(10) Pub. No.: US 2026/0166785 A1
(43) Pub. Date: Jun. 18, 2026

(54) FORMING MONOLITHIC POLYETHYLENE ARTICLES

(71) Applicant: W. L. Gore & Associates, Inc., Newark, DE (US)

(72) Inventors: Edward H. Cully, Clarksville, VA (US); Jeffrey B. Duncan, Flagstaff, AZ (US); Thomas R. McDaniel, Flagstaff, AZ (US)

(21) Appl. No.: 19/139,666

(22) PCT Filed: Dec. 15, 2023
(86) PCT No.: PCT/US2023/084349

§ 371 Date: Jun. 16, 2025

Related U.S. Application Data
(60) Provisional application No. 63/433,132, filed on Dec. 16, 2022.

(51) Int. Cl. B29C 44/56

(52) U.S. Cl. CPC B29C 44/5627; B29C 44/5681; B29K 2823/06

(57) ABSTRACT

A method of forming a polyethylene (PE) article, comprising optionally providing a first support, assembling a plurality of polyethylene substrates on the first support, the plurality of polyethylene substrates defining a PE construct, applying a second support to the PE construct such that the PE construct is positioned between the first support and the second support, positioning the first support, the PE construct, and the second support proximate a housing, and applying a force to the first support, the second support, and the PE construct such that the first support, the second support, and the PE construct expand to conform to the housing, wherein the housing limits distension of the first support, the second support, and the PE construct beyond the housing such that when the PE construct expands, an PE article is formed.

### CROSS-REFERENCE TO RELATED APPLICATION

This is a national phase application of PCT Application No. PCT/US 2023/084349, internationally filed on Dec. 15, 2023, which application claims the benefit of Provisional Application No. 63/433, 132, filed Dec. 16, 2022, which are incorporated herein by reference in their entireties for all purposes.

### FIELD

The present disclosure relates generally to apparatuses, systems, and methods for processing polyethylene. More specifically, the disclosure relates to apparatuses, systems, and methods of processing polyethylene that may be used in medical devices.

### BACKGROUND

Material selection is critical for providing functional articles. For example, implantable medical devices are often formed of specific materials that are biocompatible and provide certain functions such as cellular adhesion and so forth.

Not only is material selection important, but methods used to process materials may impart or provide specific qualities, structures, or function to the material being process that facilitate functionalities of an article formed of the material. The specific qualities imparted during processing may be necessary for the processed material to be suitable for a specific function. Selection of processing methods is important in a variety of industries, including, but not limited to the medical device industry, and more specifically for implantable medical devices. However, processed materials may be used across various industries and the same properties that are desirable in one industry may also be important in other industries.

Many materials are formed as a sheet and are then coupled and manipulated to be formed into specific structures. However, these coupling points or seems are often weak points in the manufactured article or may result in other undesirable features such as particulate accumulation, and so forth.

What is needed are materials that can be formed without such undesirable features with reliability.

### SUMMARY

The present disclosure relates to methods, articles, and devices produced by such methods for forming a monolithic expanded polyethylene (ePE) article from a polyethylene (PE) construct. For example, articles and devices produced by such methods include applying a force to the PE construct to form an PE article. The PE article may be formed such that the PE article is monolithic and seamless. The PE article may also exhibit a desirable set of features such as durability, abrasion resistance, smaller profile, high strength, and thromboresistance.

According to one example (“Example 1”), a method of forming a polyethylene (PE) article, comprises, optionally, providing a first support, assembling a plurality of polyethylene substrates on the first support, the plurality of polyethylene substrates defining a PE construct, applying a second support to the PE construct such that the PE construct is positioned between the first support and the second support, positioning the first support, the PE construct, and the second support proximate a housing, and applying a force to the first support, the second support, and the PE construct such that the first support, the second support, and the PE construct expand to conform to the housing, wherein the housing limits distension of the first support, the second support, and the PE construct beyond the housing such that when the PE construct expands, an PE article is formed.

According to another example (“Example 2”), further to Example 1, applying the force to the PE construct results in a monolithic PE article.

According to another example (“Example 3”), further to Example 1, the monolithic PE article is seamless.

According to another example (“Example 4”), further to Example 1, the method further including positioning the first support, the second support, and the PE construct about a mandrel.

According to another example (“Example 5”), further to Example 3, the mandrel is porous or perforated.

According to another example (“Example 6”), further to Example 1, the first support and the second support are formed of silicone.

According to another example (“Example 7”), further to Example 1, assembling the plurality of polyethylene components further includes assembling other components formed of materials other than PE including at least one of expanded polyethylene (ePE), polytetrafluoroethylene (PTFE) or expanded polytetrafluoroethylene (ePTFE).

According to another example (“Example 8”), further to Example 1, the method further includes heating the PE construct.

According to another example (“Example 9”), further to Example 1, applying the force to the first support, the second support, and the PE construct includes heating liquid positioned within the mandrel to about 130 degrees Celsius such that the liquid phase transitions to gas which applies the force.

According to another example (“Example 10”), further to Example 8, heating the liquid to gas results in a liquid to gas expansion ratio of about 1:1600.

According to another example (“Example 11”), further to Example 1, applying the force to the first support, the second support, and the PE construct includes releasing compressed gasses.

According to one example (“Example 12”), a method of forming a monolithic polyethylene (PE) article, comprises positioning a PE construct such that a first portion of the PE construct overlaps with a second portion of the PE construct, applying heat to the PE construct, and expanding the PE construct simultaneous with applying heat to the PE construct.

According to another example (“Example 13”), further to Example 12, positioning the PE construct includes positioning the PE construct between a first silicone support and a second silicone support.

According to another example (“Example 14”), further to Example 13, expanding the PE construct includes applying a force to one of the first silicone support and the second silicone support such that the first silicone support, the PE construct, and the second silicone support expand together.

According to another example (“Example 15”), further to Example 14, expanding the PE construct includes applying the force via pressure.

According to another example (“Example 16”), further to Example 15, the pressure is provided via heated liquid transitioning to gas.

According to another example (“Example 17”), further to Example 15, the pressure is provided via compressed gasses.

According to another example (“Example 18”), further to Example 14, expanding the PE construct simultaneously with applying heat forms a seamless monolithic PE article.

According to one example (“Example 19”), a method of forming a polyethylene (PE) article comprises assembling a PE construct onto a first shaped support, positioning a punch proximate the PE construct, applying a force to the PE construct via the punch such that the punch contacts the PE construct and pushes the PE construct into the first shaped support, the PE construct conforming to a shape of the first shaped support, applying heat to the PE construct, and releasing the punch from the PE construct to form the PE article, the PE article retaining the shape of the first shaped support.

According to another example (“Example 20”), further to Example 19, applying heat to the PE construct includes applying heat of about 130 degrees Celsius.

According to another example (“Example 21”), further to Example 19, applying heat to the PE construct densifies the PE article, the density being a gradient across the PE article.

According to another example (“Example 22”), further to Example 19, applying a force to the punch and applying heat to the PE construct are done simultaneously.

According to another example (“Example 23”), further to Example 19, applying heat to the PE construct is done while the PE construct is within the first shaped support.

The foregoing Examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a block diagram of a method of forming a polyethylene (PE) article from a plurality of polyethylene substrates, in accordance with some embodiments;

FIG. 2 is an illustration of an embodiment in which an PE article is formed from a PE construct, in accordance with some embodiments;

FIG. 3 is an illustration of a side view of the embodiment of FIG. 2, in accordance with some embodiments;

FIG. 4 is a block diagram of a method of forming a monolithic PE article, in accordance with some embodiments;

FIG. 5 is an illustration of an embodiment in which a monolithic PE article is formed, in accordance with some embodiments;

FIG. 6 is a block diagram of a method of forming an PE article using a shaped support, in accordance with some embodiments;

FIG. 7 is an illustration of a side view of an embodiment in which a polyethylene PE article is formed using a shaped support, in accordance with some embodiments;

FIGS. 8A and 8B illustrate a microstructure of PE articles of Example 1 processed above the melt temperature;

FIG. 9 illustrates thickness data for PE articles of Examples 1 and 2;

FIG. 10 illustrates bubble point data for PE articles of Examples 1 and 2;

FIG. 11 illustrates air leak data for PE articles of Examples 1 and 2; and

FIG. 12 illustrates peel data for PE articles of Example 2.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The term “laminate” as used herein refers to multiple layers of membrane, composite material, or other materials, such as, but not limited to a polymer, such as, but not limited to an elastomer, elastomeric or non-elastomeric material, and combinations thereof.

The term “film” as used herein generically refers to one or more of the membrane, composite material, or laminate.

The term “biocompatible material” as used herein generically refers to any material with biocompatible characteristics including synthetic materials, such as, but not limited to, a biocompatible polymer, or a biological material, such as, but not limited to, bovine pericardium. Biocompatible material may comprise a first film and a second film as described herein for various embodiments.

The term “polyethylene” (PE) as used herein is inclusive of all types of polyethylene, including but not limited to, expanded polyethylene (ePE).

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

The present disclosure relates to monolithic articles and devices, and methods of forming such articles and devices. Monolithic articles and devices may be formed from a starting material including a plurality of layers that are processed to form a monolithic single article where each layer of the plurality of layers is indistinguishable from each other. The monolithic articles and devices may include articles and devices where the starting material layers become integrated (e.g., enmeshed) with each other. In some embodiments, the monolithic articles may be formed such that they are seamless and do not include a seam from arranging (e.g., wrapping) the starting material layers together. Monolithic articles and devices may be desirable as they can be formed via methods that reduce undesirable features such as voiding, particulate accumulation, or poor layer adhesion. The undesirable features can lead to device failures. Reduction of such undesirable features can increase the life of devices and articles.

The monolithic articles may be formed from a polyethylene (PE) substrate. For example, the methods described herein may be implemented to form a PE substrate or PE construct into a monolithic PE article. For example, monolithic articles and devices may be produced by a method including assembling a PE substrate on a first support and a second support, positioning the first support, the PE substrate, and the second support proximate a housing, and applying a force to the first support, the PE construct, and the second support to form a PE article. The PE article may be monolithic and seamless. The PE article may also exhibit a desirable set of features such as durability, abrasion resistance, smaller profile, high strength, and thromboresistance.

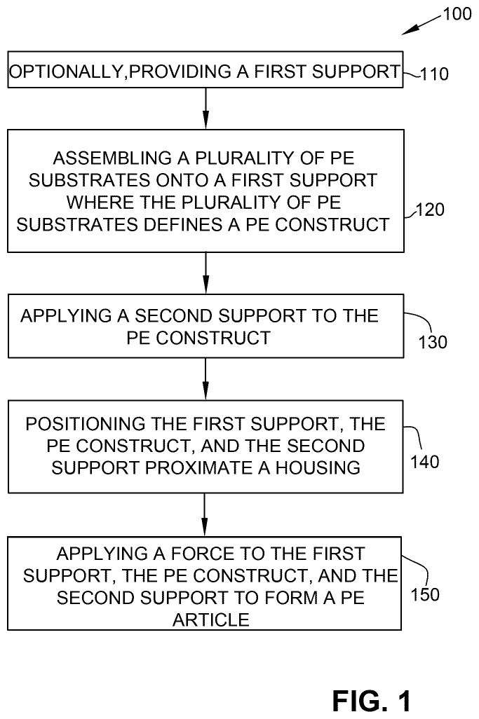

The method shown in FIG. 1 is provided as an example of the various features of the method and, although the combination of those illustrated features is clearly within the scope of invention, that example and its illustration are not meant to suggest the concepts provided herein are limited from fewer features, additional features, or alternative features to one or more of those features shown in FIG. 1.

Referring more specifically to the features of the method shown in FIG. 1, a method 100 of forming a polyethylene (PE) article from a plurality of polyethylene (PE) substrates is provided, in accordance with some embodiments. The method 100 can be implemented in a variety of contexts, including but not limited to preparing or manufacturing medical devices, which may include implantable medical devices.

Various forms of PE may be implemented in the methods, including but not limited to membranes, films, tapes, tubes, and so forth. It is further understood that the PE may be provided with various characteristics including different thicknesses, fibril and node structures, porosity, densities, and so forth. Accordingly, the embodiments discussed herein are not to be limited to specific initial conditions or forms but are understood to broadly understood to incorporate any PE starting material that is suitable for the described methods.

In some embodiments, as shown in FIG. 1, the method 100 of forming the PE article from the plurality of PE substrates may optionally include providing a first support 110, assembling a plurality of PE substrates on the first support where the plurality of PE substrates defines a PE construct 120, applying a second support to the PE construct 130, positioning the first support, the PE construct, and the second support proximate a housing 140, and applying a force to the first support, the PE construct, and the second support to form an PE article 150.

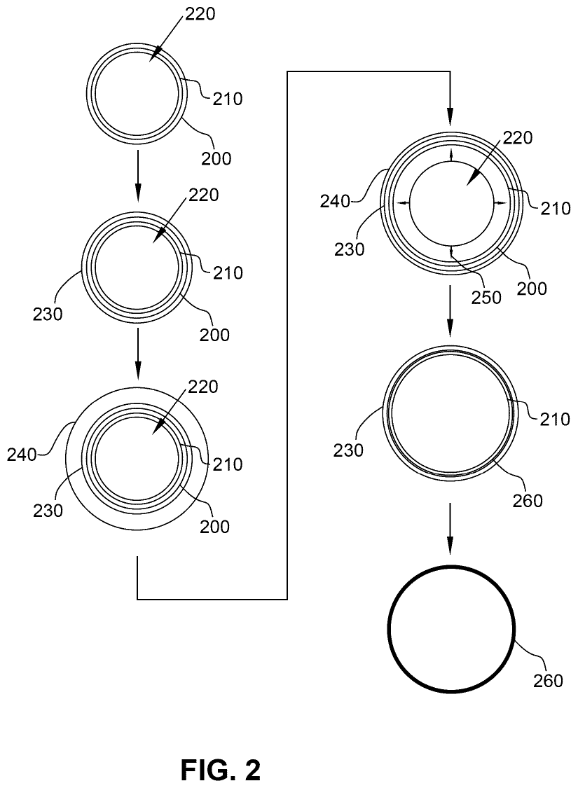

Further to FIG. 1, in optionally providing a first support 110, the first support may be formed of silicone. In some embodiments, the first support may be similar to the first support 210 as illustrated in FIG. 2. In some embodiments, the first support is provided as a silicone tube (see the first support 210 of FIG. 2). However, the first support may be provided in any shape or size appropriate for the application.

Further to FIG. 1, in assembling a plurality of PE substrates on the first support where the plurality of PE substrates defines a PE construct 120, the plurality of PE substrates may include, but is not limited to discrete sheets, tapes, films, extruded components, or laminates of PE. The plurality of PE substrates may be provided at any size or thickness as is appropriate for the application. Each of the PE substrates in the plurality of PE substrates may be provided with the same size or same thickness or may be provided in a variety of sizes and thicknesses. The plurality of PE substrates may also be provided in any shape as appropriate for the application. The PE substrates can be assembled on the first support in an environment appropriate for the application or for the materials used. The environment may include, but is not limited to, a cooled (e.g., refrigerated) environment, a room temperature environment, or a heated environment.

Furthermore, the step of assembling a plurality of PE substrates on the first support where the plurality of PE substrates defines a PE construct 120 may further include assembling other substrates formed of materials other than PE. It is understood that instead of starting with PE substrates, substrates formed of other materials, such as expanded polyethylene (ePE), polytetrafluoroethylene (PTFE), and expanded polytetrafluoroethylene (ePTFE) may also be implemented. The use of other absorbable or resorbable materials is also contemplated. For example, a composite material may be formed as described by the method herein. The composite material may include a plurality of layers such as a base layer and an outer layer. The plurality of layer may include one material type or more than one material type. The base layer and the outer layer may include biologically stable material that is suitable for direct exposure to blood or biological tissues (e.g., PTFE or PE).

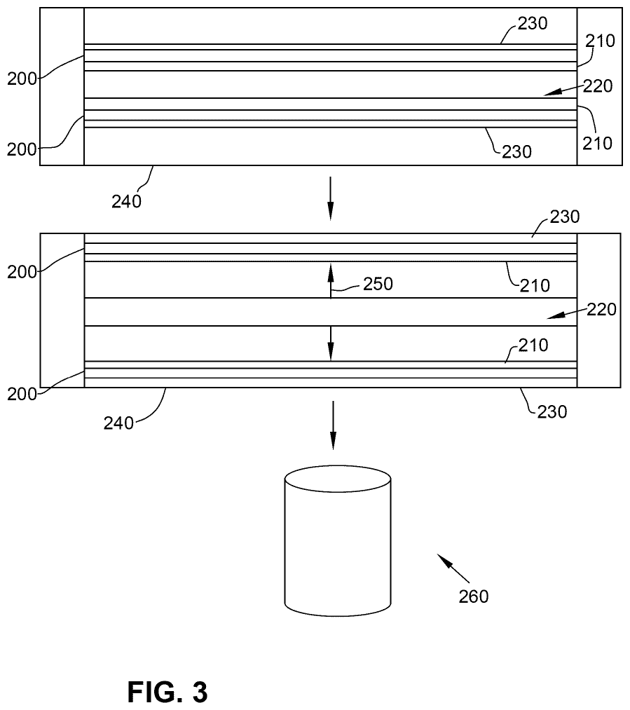

Further to FIG. 1, in applying a second support to the PE construct 130, the PE construct may be positioned between the first support and the second support. In some embodiments, the second support may also be made of silicone. The second support may be similar to the second support 230 as illustrated in FIG. 2. In some embodiments, the second support is a silicone tube (see the second support 230 of FIG. 2). However, the second support may be provided at any shape or size appropriate for the application. In some embodiments, the first support, the PE construct, and the second support may be cylindrical or tubular. This may be such that the PE construct is wrapped about the first support and the second support is wrapped about the PE constructed in a layered construct (for example, see FIGS. 2 and 3). The cylindrical configuration may be such that the first support is an inner support for the PE construct and the second support is an outer support is an outer support for the PE construct. In other configurations, the first support, the PE construct, and the second support may be flat such that the layers are applied in a stacked configuration. However, other configurations and shapes (e.g., spherical) are contemplated.

Further to FIG. 1, in positioning the first support, the PE construct, and the second support proximate a housing 140, the housing may be provided at any size or shape appropriate for the application. The housing may be similar to the housing 240 of FIG. 2 and FIG. 3. In some embodiments, the second support is positioned between the PE construct and the housing such that the second support acts as a cushion for the PE construct. Positioning the first support, the PE construct, and the second support proximate a housing 140 may further include providing a mandrel about which the first support, the second support, and the PE construct are positioned. The mandrel may be similar to the mandrel 220 illustrated in FIG. 2. In some embodiments, the mandrel may be provided within the housing.

Further to FIG. 1, the method includes applying a force to the first support, the PE construct, and the second support to form an PE article 150. The application of the force may be such that the first support (e.g., first support 210 of FIG. 2), the second support (e.g., second support 230 of FIG. 2), and the PE construct (e.g., PE construct 200 of FIG. 2) expand or distend to conform to the housing (e.g., housing 240 of FIG. 2). In some embodiments, the housing may limit distension of the first support, the second support, and the PE construct beyond the housing such that when the PE construct expands, the PE article (e.g., PE article 260 of FIG. 2) is formed. In some embodiments, when the PE construct is expanded, the PE construct conforms to the shape of the housing such that the PE article takes on the shape of the housing. In some embodiments, the first silicone support and the second silicone support may be corrugated or textured on the surface such that the corrugation or texture is imprinted onto the PE construct upon the application of force. In some embodiments, applying a force to the first support, the PE construct, and the second support to form an PE article 150 results in the formation of a monolithic PE article. In some embodiments, the monolithic PE article may be defined such that the PE construct layers become integrated (e.g., enmeshed) with each other. The monolithic PE article may be formed such that they are seamless, and the layers of the PE construct become indistinguishable from each other. Further details on structural and material property changes are discussed with respect to Examples 1 and 2.

In some embodiments, the monolithic PE article may be formed such that the layers of the PE construct become integrated (e.g., enmeshed) with each other. In some embodiments, the monolithic PE article is formed in the absence of adhesive bonding. In some embodiments, the monolithic PE article is seamless such that the layers of the PE construct are indistinguishable. In some embodiments, the monolithic PE article is dense or non-porous. In some embodiments, the monolithic PE article is textured from the textured or corrugated surfaces of the first and second supports.

In some embodiments, when the starting material is an ePE construct, a monolithic ePE article is formed. The ePE construct may be processed by the method as described above with respect to FIG. 1. In some embodiments, the monolithic ePE article is processed such that it becomes partially densified. In other embodiments, the monolithic ePE article is processed such that it becomes fully densified.

In some embodiments, the PE article (e.g., PE article 260 of FIG. 2) may be formed via the methods described herein, the methods of processing the materials being capable of imparting characteristics such as increased durability, abrasion resistance, smaller profile, high strength, and thromboresistance. This may be due to better integration of the layers of the PE construct (e.g., from the application of force instead of adhesive) which may lead to less voiding between the layers and less peeling, loosening, or unraveling of the layers. By excluding these features, fewer potential failure points are formed in the PE article. Forming an PE article without a seam can also lead to fewer failure propagation points and a reduction in failure between the layers. This in turn may lead to a longer life of the PE article. Further, forming an PE article without a seam may also increase thromboresistance by reducing the areas for which thrombus could form. The PE article formed by method 100 may have a thin-wall profile. In some embodiments, the thin-wall profile of the PE article may be in a thickness range of about 0.001 inches to about 0.040 inches. In some embodiments, the thickness may be in a range of about 0.001 inches to about 0.004 inches, a range of about 0.004 inches to about 0.008 inches, a range of about 0.008 to about 0.012 inches, a range of about 0.012 inches to about 0.016 inches, a range of about 0.016 inches to about 0.020 inches, a range of about 0.020 inches to about 0.024 inches, a range of about 0.024 inches to about 0.028 inches, a range of about 0.028 inches to about 0.032 inches, a range of about 0.032 inches to about 0.036 inches, and a range of about 0.036 inches to about 0.040 inches. The thickness may be measured at the perimeter of the PE article after integration or enmeshing of the layers of the PE construct.

In some embodiments, the PE article may be formed into or provided as a medical device or a component of a medical device. The medical device may include an implantable medical device. The PE article may be formed as a tubular construct and may be implemented, for example, as a graft. The PE article may be formed as a flat construct and may be implemented, for example, as a hernia patch, a cardiovascular patch, a neuro membrane, and so forth.

In some embodiments, applying a force to the first support, the PE construct, and the second support to form an PE article 150 may further include heating a liquid such that the liquid transitions to a gas. In some embodiments, the liquid may be heated at about 130° C. In other embodiments, the liquid may be heated to a temperature between about 110-130° C., between about 130-150° C., or between 150-180° C. In some embodiments, the liquid may be liquid water and the liquid water may be heated such that the liquid water phase transitions to steam. As the liquid undergoes the phase change, the gas expands and creates pressure which applies the force to the first support, the PE construct, and the second support. In some embodiments, heating the liquid may be done when the liquid is positioned within the mandrel about which the first support, the PE construct, and the second support are positioned. In some embodiments, the mandrel is porous or perforated such that the gas can be released through the mandrel. In some embodiments, the mandrel is hollow to allow the water to enter an interior of the mandrel. In some embodiments, heating the liquid to gas results in a liquid to gas expansion ratio of about 1:1600.

In other embodiments, applying the force to the first support, the PE construct, and the second support to form an PE article 150 may further include releasing compressed gasses. In some embodiments, the released compressed gases may apply the force by exposing the first support (e.g., first support 210 of FIG. 2), the PE construct (e.g., PE construct 200 of FIG. 2), and the second support (e.g., second support 230 of FIG. 2) to the compressed gas as it is released. The release of the compressed gas may apply force to the first support, the PE construct, and the second support through either the velocity with which the compressed gas is released or by the pressure gradient across the first support, the PE construct, and the second support on the interior (e.g., the side in contact with the gas) and the exterior sides. In some embodiments, the compressed gasses may be inert. In some embodiments, the compressed gasses may be stored within and released from the mandrel (e.g., mandrel 220 of FIG. 2) to apply the force. In other embodiments, the housing may connect to an external source of compressed gasses where the external source applies the compressed gases to the first support, the PE construct and the second support to apply the force.

In some embodiments, the method 100 of forming the PE article from the plurality of PE substrates may further include heating the PE construct. The PE construct (e.g., PE construct 200 of FIG. 2) may be heated to a temperature above the melt temperature or the glass transition temperature of PE. The temperature may be at about 130° C., between about 110-130° C., between about 130-150° C., or between about 150-180° C. The heat may be provided from a heated environment (e.g., an oven). The heat may be applied from a heat source directed on an exterior surface of the PE construct (e.g., the portion of the PE construct in contact with the second support) or the heat may be applied from a heat source directed on an interior surface of the PE construct (e.g., the portion of the PE construct in contact with the first support, or within a lumen). In some embodiments, at least a portion of the heat that is applied to the PE construct is provided by the same mechanism for applying the force to expand the PE construct such as the liquid that is heated and transitioned to a gas or the release of compressed gases.

In some embodiments, heating the PE construct (e.g., PE construct 200 of FIG. 2) may be done prior to applying the force to the first support, the PE construct, and the second support to form an PE article 150. In some embodiments, heating the PE construct may be done simultaneously to applying the force to the first support, the PE construct, and the second support to form an PE article 150. In some embodiments, applying heat to the PE construct will result in the formation of a monolithic structure (e.g., a seamless tube). In some embodiments, the PE construct may be shaped into a medical device, or a component of a medical device. In some embodiments in which the PE construct includes ePE, applying heat and the force to the PE construct will densify the PE construct.

In some embodiments, the PE construct is cooled after having been subjected to heat. The PE construct may be cooled at room temperature, may be placed in an environment that is cooler than room temperature (e.g., a freezer), or may be slowly cooled in an environment with a temperature higher than room temperature. In some embodiments, the environment in which the densified PE construct is cooled may be at a stable temperature or may be a variable temperature. In some embodiments, the variable temperature of the environment allows the PE construct to be cooled at a controlled rate. The rate of cooling of the PE construct may be constant or may be variable.

FIG. 2 is an illustration of an embodiment in which an PE article is formed from a PE construct, in accordance with some embodiments. In some embodiments, the illustration of FIG. 2 follows the method 100 as described with respect to FIG. 1.

FIG. 2 illustrates a PE construct 200. In some embodiments, the PE construct 200 may include a plurality of PE substrates. In this embodiment, the PE construct 200 is shown in contact with a first support 210. The PE construct 200 may be applied on an outer side of the first support 210. In this embodiment, an inner side of the first support 210 is shown in contact with a mandrel 220. The first support may be applied around an exterior surface of the mandrel. In this embodiment, the PE construct 200, the first support 210, and the mandrel 220 are all shown in a cylindrical shape. However, other shapes for the PE construct 200, the first support 210, and the mandrel 220 are contemplated, such as spherical, rectangular, and so forth.

A second support 230 may be applied to the PE construct 200. In this embodiment, the second support 230 is applied to an exterior side of the PE construct 200 such that the PE construct 200 is positioned between the first support 210 and the second support 230. In this embodiment, the first support 210, the PE construct 200, and the first support 230 are all positioned about the mandrel 220. In some embodiments, the first support 210 and the second support 230 are made of silicone.

However, embodiments in which the first support 210 and the second support 230 are made of a compliant material other than silicone are contemplated.

The first support 210, the PE construct 200, and the second support 230 are positioned proximate a housing 240. In some embodiments, the mandrel 220 is part of the housing 240 and in other embodiments, the mandrel 220 may be discrete from the housing 240 and placed proximate to the housing 240. In further embodiments, the mandrel 220 may be discrete from the housing 240 and the housing 240 may be placed such that the housing 240 surrounds the mandrel 220. In this embodiment, the housing 240 has a cylindrical perimeter. However, other perimeter shapes for the housing 240 may be utilized depending on the target shape of the final PE article.

Further to FIG. 2, after the first support 210, the PE construct 200, and the second support 230 are positioned proximate to the housing 240, a force 250 may be applied. The force 250 may be applied to the first support 210, the PE construct 200, and the second support 230 such that the first support 210, the PE construct 200, and the second support 230 expand to conform to the housing 240. The housing 240 is positioned to limit distension of the first support 210, the PE construct 200, and the second support 230 beyond the housing 240. When the PE construct 200 expands, an PE article 260 is formed.

In this embodiment, the force 250 is a radial force in a radially outward direction. In some embodiments, the force 250 applied to the PE construct may be a tensile force applied in a lateral direction or a longitudinal direction. The tensile force may include stretching the PE construct to a longer length. In further embodiments, the force 250 applied to the PE construct may be a combination of the radial force and the tensile force. In this embodiment, the mandrel 210 is porous or perforated such that the force 250 can come from the mandrel 220. In some embodiments, the mandrel 220 may have liquid positioned within the mandrel where the liquid is heated such that the liquid phase transitions to gas, the gas travels through the pores or perforations, and the gas applies the force 250. In other embodiments, compressed gasses are released to apply the force 250.

Further to FIG. 2, applying the force 250 to the PE construct results in the formation of a PE article 260. When the mandrel 220 and housing 240 are removed, the formed PE article 260 is plastically deformed and retains the expanded radial dimension of the housing. The first support 210 and the second support 230 may be elastically deformed such that the first support 210 and the second support 230 retain the expanded radial dimension temporarily, but then may rebound back to a smaller dimension. This may allow the first support 210 and the second support 230 to be reused in future manufacturing. In this embodiment, when the first support 210 and the second support 230 are removed, the PE article 260 continues to retrain the expanded radial dimension. In some embodiments, the PE article 260 is a monolithic PE article. In some embodiments, the monolithic PE article is seamless. In this embodiment, the monolithic PE article 260 was formed in the absence of an adhesive and instead the PE construct layers integrated or enmeshed via the application of the force 250 to form the PE article.

In some embodiments, as discussed above with respect to FIG. 1, the PE article 260 may be formed with desirable characteristics such as increased durability, abrasion resistance, smaller profile, high strength, and thromboresistance.

In this embodiment, the PE article 260 may be formed into a tubular construct and may be implemented, for example, as a graft. Other medical devices or components that are tubular are also contemplated.

FIG. 3 is an illustration of a side view of the embodiment of FIG. 2, in accordance with some embodiments. In this embodiment, the housing 240 is shown as a shape with a constant circular cross-section. The constant circular cross section of the housing 240 forms the PE article 260 with a corresponding constant circular cross-section, which, may lead to a constant thickness across a length of the PE article 260. This may form constant circular cross-section PE articles for medical devices or medical device components. For example, grafts or graft components may be formed. However, in other embodiments, the housing 240 may be provided with a variable cross-section. For example, some embodiments may have one end of the housing 240 may have the round cross-section and the other end may have a D-shaped cross-section. This may form variable cross-section PE articles for medical devices or medical device components. For example, the variable cross-section housing 240 may be used to form bifurcated grafts or bifurcated graft components. In other examples, some embodiments may have a housing with variable thickness such that the PE article is formed with variable thickness along a length of the PE article 260.

In some embodiments, the layers of the PE construct 200 may be cigarette wrapped longitudinally about the first support 210. However, other types of configurations are contemplated, including but not limited to, helical wrapping. In some embodiments, a seam is formed in the PE construct 200 longitudinally along the PE construct 200 prior to heating and expansion. However, during the method steps (e.g., the method 100 as described in FIG. 1), the seam disappears to forms a seamless PE article 260 (e.g., a seamless tubular construct).

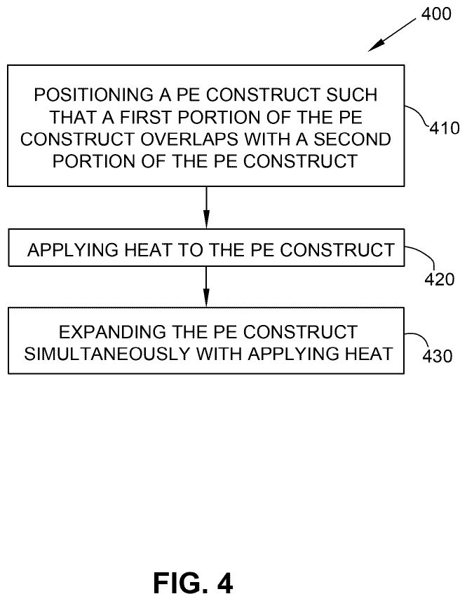

FIG. 4 is a block diagram of a method 400 of forming a monolithic polyethylene (PE) article, in accordance with some embodiments. The method 400 can be implemented in a variety of contexts, including but not limited to medical devices, which may include implantable medical devices.

In some embodiments, as shown in FIG. 4, the method 400 of forming the monolithic polyethylene (PE) article may include positioning a PE construct such that a first portion of the PE construct overlaps with a second portion of the PE construct 410, applying heat to the PE construct 420, and expanding the PE construct simultaneously with applying heat 430.

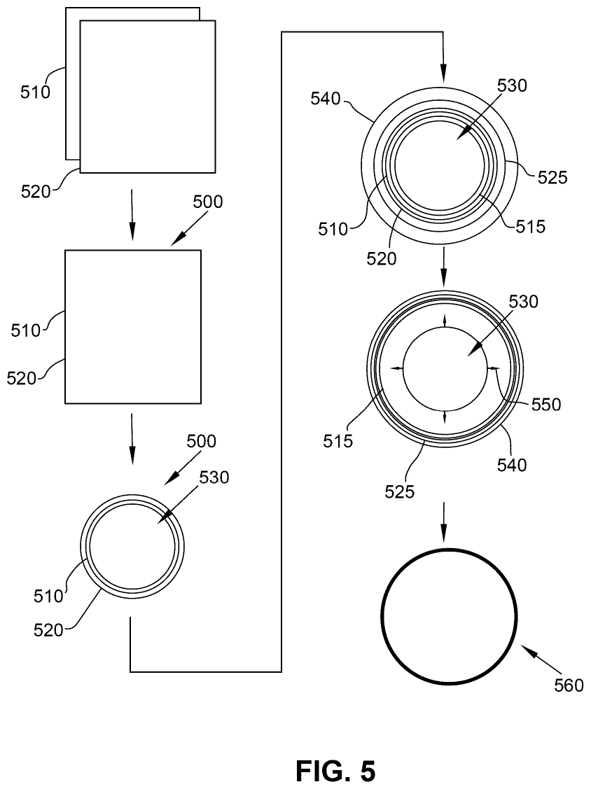

Further to FIG. 4, when positioning the PE construct such that the first portion of the PE construct overlaps with the second portion of the PE construct 410, it is understood that in some embodiments, the PE construct may be made of a plurality of PE substrates. In other embodiments, the plurality of substrates may be other forms of polyethylene, including but not limited to ePE substrates or PTFE substrates. The plurality of components may include, but are not limited to, discrete sheets, tapes, films, extruded components, or laminates. In some embodiments, the first portion of the PE construct (e.g., the first portion 510 of FIG. 5) may be one of the components in the plurality of components and the second portion of the PE construct (e.g., the second portion 520 of FIG. 5) may be a different one of the components in the plurality of components. In some embodiments, the first portion of the PE construct and second portion of the PE construct may be the same shape and size such that overlapping the first portion and second portion of the PE construct covers the other of the first and second portion of the PE construct. In other embodiments, the first portion of the PE construct and the second portion of the PE construct may be a different shape and size.

Positioning the PE construct such that the first portion of the PE construct overlaps with the second portion of the PE construct 410 may further include positioning the PE construct (e.g., PE construct 500 of FIG. 5) between a first silicone support (e.g., first silicone support 515 of FIG. 5) and a second silicone support (e.g., second silicone support 525 of FIG. 5). In some embodiments, the PE construct is sandwiched between the first silicone support and the second silicone support. In some embodiments, the first silicone support and the second silicone supports are tubes. In some embodiments, the PE construct is wrapped around the first silicone support such that the PE construct is formed as a PE construct tube. In some embodiments, the PE construct tube is configured such that the second portion of the PE construct is exterior to the first portion of the PE construct, as shown in FIG. 5. In other embodiments, the reverse configuration of the PE construct is formed where the first portion of the PE construct is exterior to the second portion of the PE construct. This configuration of the PE construct tube may only be apparent prior to heating and/or applying force to the PE construct tube. The PE construct may have multiple layers that together form the PE construct. In some embodiments, the PE construct is wrapped about a mandrel (e.g., the mandrel 530 of FIG. 5).

Further to FIG. 4, applying heat to the PE construct 420 may be done at a temperature around the melt temperature or the glass transition temperature of PE. In some embodiments, the heat may be applied at a temperature around 130° C., between about 110-130° C., between about 130-150° C., or between about 150-180° C. In some embodiments, the heat may be provided from a heated environment (e.g., an oven). In some embodiments, the heat may be applied from a heat source directed on an exterior surface of the PE construct (e.g., the portion of the PE construct in contact with the second support) or the heat may be applied from a heat source directed on an interior surface of the PE construct (e.g., the portion of the PE construct in contact with the first support, or within a lumen).

Further to FIG. 4, expanding the PE construct simultaneously with applying heat 430 may further include applying a force to one of the first silicone support and the second silicone support such that the first silicone support, the PE construct, and the second silicone support expand together. In some embodiments, the first silicone support, the PE construct, and the second silicone support expand together in a radial direction to form a tube. In other embodiments, the first silicone support, the PE construct, and the second silicone support are compressed together in an axial direction (e.g., a lateral direction or a longitudinal direction) to form a flat construct. In further embodiments, the first silicone support, the PE construct, and the second silicone support expand together in both the radial direction and the axial direction. In some embodiments, the heat may be applied by the mandrel (e.g., the mandrel 530 of FIG. 5).

In some embodiments, expanding the PE construct simultaneously with applying heat 430 may further include applying the force may be via pressure. In some embodiments, the heat and/or pressure are provided via heated liquid transitioning to gas. In some embodiments, the heated liquid is water, and the gas is steam. The heated liquid transitioning to gas may be applied from an interior side of the tubular PE construct to expand the tubular PE construct in a radial direction. In some embodiments, the heated liquid may be provided within the mandrel (e.g., the mandrel 530 of FIG. 5) and applied to the PE construct through pores or perforations in the mandrel surface.

In other embodiments, the heat and/or pressure is provided via compressed gasses. The compressed gases may include inert compressed gases and the pressure from the compressed gases may be applied to an interior of the tubular PE construct (e.g., from the mandrel 530 of FIG. 5) to expand the tubular PE construct in a radial direction. In some embodiments, the released compressed gases may apply the heat and/or pressure by exposing the PE construct (e.g., PE construct 500 of FIG. 5) to the compressed gas as it is released. The release of the compressed gas may apply heat and/or pressure through either the velocity with which the compressed gas is released or by the pressure gradient across the interior (e.g., the side in contact with the gas) and the exterior sides of the tubular PE construct.

In some embodiments, expanding the PE construct simultaneously with applying heat 430 may result in forming a seamless monolithic PE article. In this embodiment, the first portion of the PE construct may be indistinguishable from the second portion of the PE construct due to the monolithic PE article being seamless.

The first portion of the PE construct may enmesh or integrate with the second portion of the PE construct.

In some embodiments, the monolithic PE article (e.g., monolithic PE article 560 of FIG. 5) may be formed via the methods described herein, the methods of processing the materials being capable of imparting characteristics such as increased durability, abrasion resistance, smaller profile, high strength, and thromboresistance.

This may be due to better integration of the layers of the PE construct (e.g., from the application of force instead of adhesive) which may lead to less voiding between the layers, less peeling, loosening, or unraveling of the layers. By excluding these features, fewer potential failure points are formed in the PE article. Forming an PE article without a seam can also lead to fewer failure propagation points and a reduction in failure between the layers. This in turn may lead to a longer life of the monolithic PE article. Further, forming an PE article without a seam may also increase thromboresistance by reducing the areas for which thrombus could form. The monolithic PE article formed by method 400 may have a thin-wall profile. In some embodiments, the thickness may be in a range of about 0.001 inches to about 0.004 inches, a range of about 0.004 inches to about 0.008 inches, a range of about 0.008 to about 0.012 inches, a range of about 0.012 inches to about 0.016 inches, a range of about 0.016 inches to about 0.020 inches, a range of about 0.020 inches to about 0.024 inches, a range of about 0.024 inches to about 0.028 inches, a range of about 0.028 inches to about 0.032 inches, a range of about 0.032 inches to about 0.036 inches, and a range of about 0.036 inches to about 0.040 inches.

In some embodiments, the PE article may be formed into or provided as a medical device or a component of a medical device. The medical device may include an implantable medical device. The PE article may be formed as a tubular construct and may be implemented, for example, as a graft. The PE article may be formed as a flat construct and may be implemented, for example, as a hernia patch, a cardiovascular patch, a neuro membrane, and so forth.

FIG. 5 is an illustration of an embodiment in which a monolithic (PE) article is formed, in accordance with some embodiments. In some embodiments, the illustration of FIG. 5 follows the method 400 as described in FIG. 4.

FIG. 5 shows a first portion of the PE construct 510 and a second portion of the PE construct 520 offset from each other and partially overlapping. In some embodiments, the first portion of the PE construct 510 and the second portion of the PE construct 520 may be the same in shape and size. In other embodiments, the first portion of the PE construct 510 and the second portion of the PE construct 520 may be different in shape and size. The PE construct 500 may include an overlapping stack of PE portions including the first and second portions of the PE construct 510, 520. In this embodiment, the first and second portions of the PE constructs are substantially the same shape and size such that the second portion of the PE construct 520 can fully cover the first position of the PE construct 510.

Similar to the embodiment shown in FIG. 2, the PE construct 500 can be applied to a mandrel 530. In this embodiment, the PE construct 500 is wrapped into a tubular shape around the mandrel 530. In some embodiments, the PE construct 500 can be positioned between a first silicone support 515 and a second silicone support 525. In some embodiments, the first silicone support 515 and the second silicone support 525 are substantially the same as the first silicone support 210 of FIG. 2 and the second silicone support 230 of FIG. 2. Further, in some embodiments, the PE construct may be positioned proximate a housing 540. In some embodiments, the PE construction is positioned within the housing 540.

In some embodiments, heat may be applied to the PE construct 500 at a temperature around the glass transition temperature of the material. The temperature may be applied at about 130° C., between about 110-130° C., between about 130-150° C., or between about 150-180° C. In some embodiments, the PE construct 500 may be expanded simultaneously with applying heat to the PE construct 500. Similar to FIG. 2, expanding the PE may include applying a force 550. In this embodiment, the force 550 may be a radial outward force and may be applied from the mandrel 530. In some embodiments, the force 530 may be a pressure force where the pressure comes from heated water transitioning to steam or from the release of compressed gases.

After applying heat to the PE construct 500 and expanding the PE construct 500, a seamless monolithic PE article 560 is formed. The seamless PE article 560 is comprised of the first portion and second portion of the PE construct portions 510, 520. However, upon forming the seamless monolithic PE article 560, the first and second PE construct portions 510, 520 are indistinguishable from each other and are integrated or enmeshed together.

In some embodiments, as discussed above with respect to FIG. 4, the PE article 560 may be formed with desirable characteristics such as increased durability, abrasion resistance, smaller profile, high strength, and thromboresistance.

In this embodiment, the monolithic PE article 560 may be formed into as a tubular construct and may be implemented, for example, as a graft. Other medical devices or components that are tubular are also contemplated.

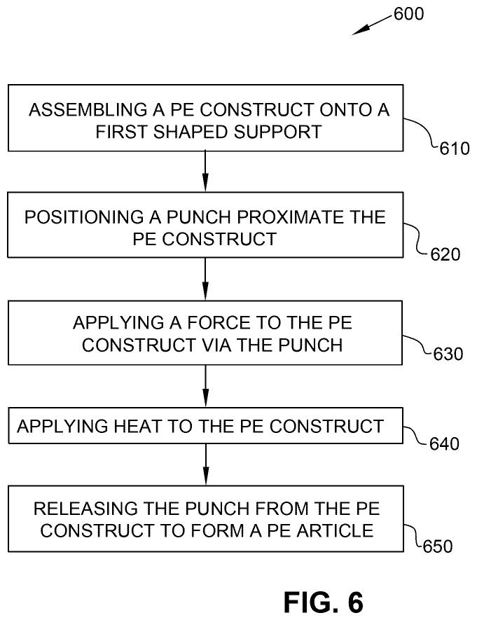

FIG. 6 is a block diagram of a method 600 of forming an expanded polyethylene (ePE) article using a shaped support, in accordance with some embodiments. The method 600 can be implemented in a variety of contexts, including but not limited to medical devices, which may include implantable medical devices.

In some embodiments, as shown in FIG. 6, the method 600 of forming the PE article may include assembling a PE construct onto a first shaped support 610, positioning a punch proximate the PE construct 620, applying a force to the PE construct 620 via the punch 630, applying heat to the PE construct 640, and releasing the punch from the PE construct to form a PE article 650.

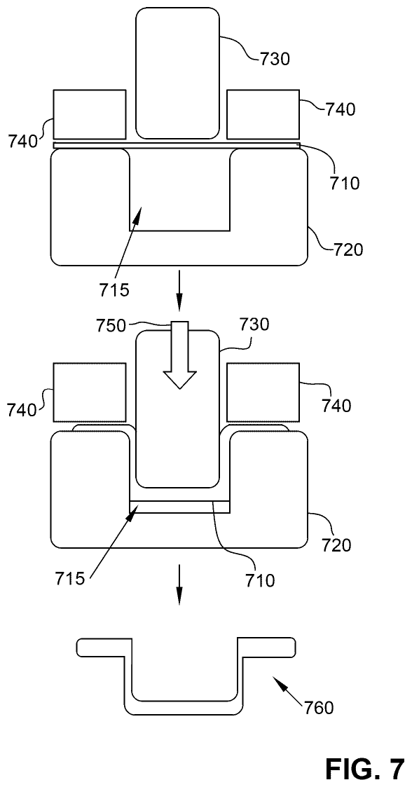

Further to FIG. 6, assembling the PE construct onto the first shaped support 610, may further include using a secondary support to hold the PE construct in place (e.g., the secondary supports 740 of FIG. 7). In some embodiments, the first shaped support (e.g., first shaped support 720 of FIG. 7) may be made of a rigid material. In other embodiments, the first shaped support may be made of a compliant material (e.g., silicone).

Further to FIG. 6, positioning the punch proximate to the PE construct 620, may further include providing a shaped punch (see the punch 730 of FIG. 7). In some embodiments, the shaped punch may include, but is not limited to, a rounded edge or a straight edge. The rounded edge or straight edge may be complementary to the first shaped support. In some embodiments, the shaped punch may be shaped to fit within the first shaped support (see FIG. 7). In other embodiments, the shape of the shaped punch may not correspond to the shape of the first shaped support.

Further to FIG. 6, applying the force to the PE construct via the punch 630, may further include applying the force to the PE construct via the punch such that the punch contacts the PE construct and pushes the PE construct into the first shaped support. The PE construct may conform to the shape of the first shaped support. In some embodiments (e.g., the embodiment of FIG. 7) the first shaped support may have a concave shape and the PE construct is pushed into the concave shape by the punch and the PE construct stretches to conform to the concave shape.

Further to FIG. 6, applying heat to the PE construct 640 may include applying heat to the PE construct at a temperature around the melt temperature or the glass transition temperature of the PE construct. The temperature may be applied at about 130° C., between about 110-130° C., between about 130-150° C., or between about 150-180° C. In some embodiments, the heat may be applied to the PE construct from the punch, such that the punch is a heated punch. In other embodiments, the heat may be applied to the PE construct from the first shaped support. In further embodiments, the heat may be applied to the PE construct from the environment (e.g., an oven or heated environment). In some embodiments, applying heat to the PE construct 640 is done while the PE construct is within the first shaped support to form a PE article (e.g., PE article 760 of FIG. 7).

In some embodiments, applying heat to the PE construct 640 densifies the PE article. In some embodiments, the PE article has a density gradient across the article. In this embodiment, the portion of the PE article with a higher density may be the portion of the PE construct that is stretched furthest into the shape of the first support (see the PE construct 710 of FIG. 7). In other embodiments, the PE article may be uniformly densified. In some embodiments, the PE article is monolithic. In some embodiments, the PE article is seamless.

In some embodiments, applying the force to the PE construct via the punch 630 and applying heat to the PE construct 640 are done simultaneously. In other embodiments, applying the force to the PE construct via the punch 630 is done prior to applying heat to the PE construct 640. In further embodiments, applying heat to the PE construct 640 is done prior to applying the force to the PE construct via the punch 630.

Further to FIG. 6, releasing the punch from the PE construct to form the PE article 650 may further include the PE article retaining the shape of the first shaped support. In some embodiments, the PE article is a monolithic PE article. In some embodiments, the monolithic PE article may be formed with desirable characteristics such as increased durability, abrasion resistance, smaller profile, high strength, and thromboresistance. This may be due to better integration and in-meshing of the layers of the PE construct (e.g., from the application of force instead of adhesive) which may lead to less voiding between the layers, less peeling, loosening, or unraveling of the layers. This, in turn, may lead to fewer failure points in the PE article. Forming an PE article without a seam can also lead to fewer failure propagation points. All of which may lead to a longer life of the PE article. Further, forming an PE article without a seam may also increase thromboresistance.

In some embodiments, the PE article may be formed into or provided as a medical device or a component of a medical device. The medical device may include an implantable medical device. The PE article may be formed as a tubular construct and may be implemented, for example, as a graft. The PE article may be formed as a flat construct and may be implemented, for example, as a hernia patch, a cardiovascular patch, a neuro membrane, and so forth.

FIG. 7 is an illustration of a side view of an embodiment in which an expanded polyethylene (ePE) article is formed using a shaped support, in accordance with some embodiments. In some embodiments, the illustration of FIG. 7 follows the method 600 as described in FIG. 6.

FIG. 7 shows a PE construct 710 assembled onto a first shaped support 720. In some embodiments, the PE construct 710 may include a plurality of PE substrates. In some embodiments, the plurality of PE substrates may include, but is not limited to discrete sheets, tapes, films, extruded components, or laminates of PE. In some embodiments, the first shaped support 720 has a concave portion 715 that defines the first shape. In some embodiments, the PE construct 710 is held in place by a secondary support 740. In some embodiments, the first shaped support is made of a compliant material (e.g. silicone). In other embodiments, the first shaped support may be made of a rigid material. The first shaped support 720 and the secondary supports may be made of the same material or from different materials. A punch 730 may be placed proximate to the PE construct 710. In this embodiment, the punch 730 may also be placed proximate the set of secondary supports 740.

Further to FIG. 7, a force 750 may be applied to the PE construct 710 via the punch 730. The force 750 may be applied such that the punch 730 contacts the PE construct 710 and may push or draw the PE construct 710 into the first shaped support 720. When the PE construct 710 is pushed into the first shaped support 720, the PE construct 710 may conform to the shape 715 of the first shaped support 720. In this embodiment, the PE construct 710 conforms to the concave shape 715 of the first shaped support 720. In this embodiment, the PE construct 710 is operable to stretch or distend upon the application of the force 750 such that the PE construct 710 stretches to conform to the concave shape 715. In some embodiments, a force may also be applied to the secondary support 740 to further shape the PE construct 710. In other embodiments, no force may be applied to the secondary support 740.

In some embodiments, heat may be applied to the PE construct 710 simultaneously to applying the force 750 to the PE construct. The heat may be applied at a temperature around the glass transition temperature of PE. The temperature may be at about 130° C., between about 110-130° C., between about 130-150° C., or between 150-180° C. In some embodiments, applying heat to the PE construct 710 may be done while the PE construct 710 is within the first shaped support 720. In some embodiments, applying heat to the PE construct 710 densifies the PE construct. In some embodiments, the PE construct 710 may be uniformly densified. In other embodiments, the PE construct 710 may densified such that a density gradient is formed across the PE construct 710.

Further to FIG. 7, the punch 730 may be released from the PE construct 710 to form an PE article 760. In some embodiments, the PE article may retain the shape 715 of the first shaped support 720. In some embodiments, the PE article retains the density gradient formed on the PE construct 710. In some embodiments, the PE article is a monolithic PE article. In some embodiments, the PE article is seamless.

### EXAMPLES

### Example 1

In a first example, three PE articles were heated to temperatures above the melt temperature. A first, second, and third PE article 800, 802, 804 comprised a first, porous PE film. The three PE articles comprised expanded polyethylene (ePE), however, similar concepts may be observed in other PE articles. The first PE article 800 was heated to about 127° C., the second PE article 802 was heated to about 130° C., and the third PE article 804 was heated to about 133° C.

The first PE article 800, the second PE article 802, and the third PE article 804 where each shaped as a tube and then heated. Heat was substantially uniformly applied to each of the first, second, and third PE articles 800, 802, 804 using a mandrel, though other heating sources may be used. When heating each of the first, second, and third PE articles 800, 802, 804, pressure was held constant without vacuum.

Constant, low pressure of approximately 2 psi was applied using an overwrap.

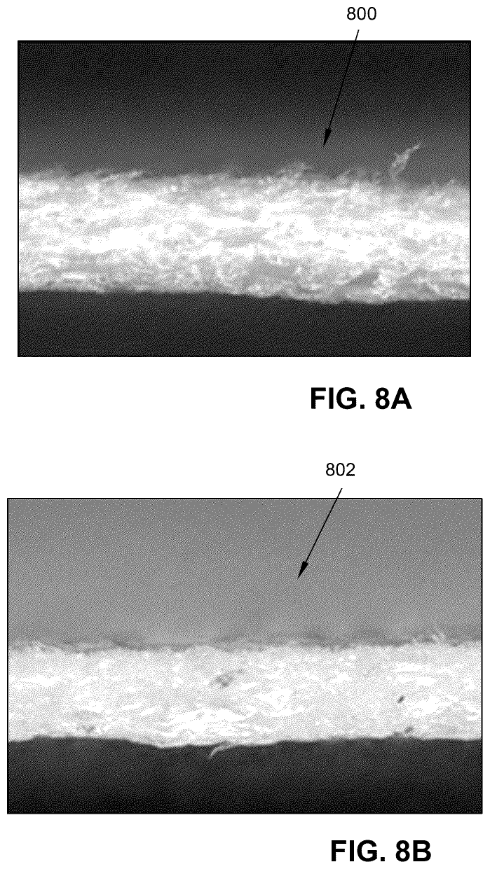

FIG. 8A shows the first PE article 800 after being heated to 127° C. and then cooled. FIG. 8B shows the second PE article 802 after being heated to 130° C. and then cooled. As observed, as process temperature is increased above the melt temperature, the PE article melts, or layers within the PE article melt, such that the material contracts and densifies. As shown, the second PE article 802 has less visible layering or less space within the PE article, further showing a more densified, or more condensed material as compared to the first PE article 800. The loss of visible layers or less space within the PE article is also an indication of a more monolithic structure where distinction between individual layers is reduced. Additionally, as shown, the second PE article 802 decreases in thickness, and is more compact, relative to the first PE article 800. The second PE article 802 also appears to tighten or densify such that the microstructure condenses.

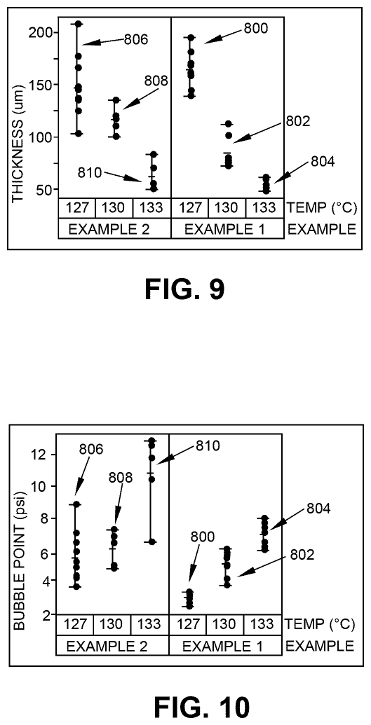

Turning to FIG. 9, the thickness of the first, second, and third PE articles 800, 802, 804 were measured in microns (μm) after the respective articles were heated. As shown by the data, as processing temperature increases above the melt temperature, thickness of the respective article decreases. In other words, a thickness of the third PE article 804 is smaller than a thickness of the second PE article 802, and the thickness of the second PE article 802 is smaller than a thickness the first PE article 800. As described with respect to FIGS. 8A-8B, the decrease in thickness may be correlated to densification and contraction of the PE article, condensing of the microstructure of the PE article, and a more monolithic structure.

Turning to FIG. 10, the bubble point of the first, second, and third PE articles 800, 802, 804 were measured in psi. As shown by the data, as processing temperature increases above the melt temperature, the bubble point of the respective article increases. The bubble point may be correlated to a pore size present in the PE article. As bubble point increases, it indicates that the pore size of the article decreases. In other words, a pore size of the third PE article 804 is smaller than a pore size of the second PE article 802, and the pore size of the second PE article 802 is smaller than a pore size of the first PE article 800. As described with respect to FIGS. 8A-8B, the increase in bubble point may also be correlated to densification and contraction of the PE article, condensing of the microstructure of the PE article, and/or and a more monolithic structure.

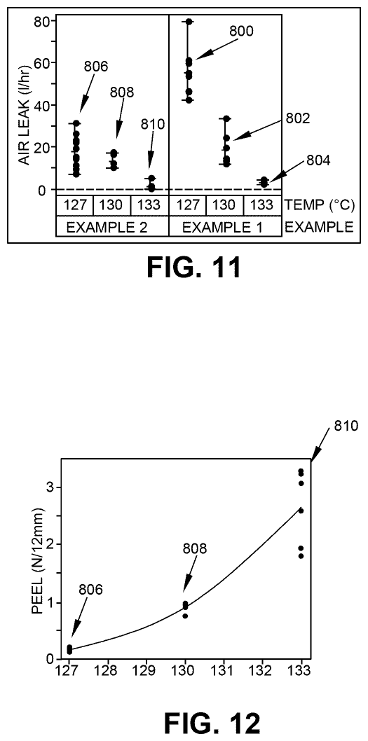

Turning to FIG. 11, airflow, or air leak through the PE article was measured for the first, second, and third PE articles 800, 802, 804 in liters per hour (W/hr). The airflow measurement was done using leak detection equipment from ATEQ®. As processing temperature was increased above the melt temperature, the air leak of the respective article decreased. The air leak volume may be correlated to a pore size present in the PE article, as larger pore sizes may allow more air to leak through the PE article. This indicates that the pore size of the respective articles decreased as processing temperature was increased. In other words, a pore size of the third PE article 804 is smaller than a pore size of the second PE article 802, and the pore size of the second PE article 802 is smaller than a pore size of the first PE article 800. As described with respect to FIGS. 8A-8B, the decrease in air leak may be correlated to densification and contraction of the PE article, condensing of the microstructure of the PE article, and/or a more monolithic structure.

Additionally, the pore size may correspond to an ability of the article to selectively allow or reduce cellular ingress, ingrowth, and/or attachment within its structure. A smaller pore size may allow the respective article to reduce or limit cellular ingress therethrough, which may be desirable in some applications, including but not limited to aortic devices. A larger pore size may allow the respective article to allow cellular ingress therethrough. As such, processing temperature may be selected to increase or decrease pore sizes as desired, to either allow or reduce cellular ingrowth, respectively.

Though the above example were described with respect to tubular shaped PE articles, flat PE articles, or other shapes of PE articles, may show similar behavior, and similar material property changes, upon being heated to a temperature above the melt.

### Example 2

In a second example, three PE articles were heated to temperatures above the melt. A fourth, fifth, and sixth PE article 806, 808, 810 comprised a second, porous PE film, which was different than the first porous PE film of Example 1. The three PE articles comprised expanded polyethylene (ePE), however, similar concepts may be observed in other PE articles. The fourth PE article 806 was heated to about 127°C. a fifth PE article 808 was heated to about 130° C., and a sixth PE article 810 was heated to about 133° C.

Similar to Example 1, the fourth PE article 806, the fifth PE article 808, and the sixth PE article 810 were each shaped as a tube prior to heating. Heat was substantially uniformly applied to each of the fourth, fifth, and sixth PE articles 806, 808, 810 using a mandrel, though other heating sources may be used. When heating each of the fourth, fifth, and sixth PE articles 806, 808, 810, pressure was held constant without vacuum. Constant, low pressure of approximately 2 psi was applied using an overwrap.

Similar to Example 1, the thickness, bubble point, and air leak were measured for each of the fourth, fifth, and sixth PE articles 806, 808, 810. The trends of the material properties were similar to those found in Example 1. As shown in FIG. 9, as processing temperature was increased above the melt temperature, thickness of the respective PE article decreased. As shown in FIG. 10, as processing temperature was increased above the melt temperature, bubble point increased. As shown in FIG. 11, as processing temperature was increased above the melt temperature, the air leak of the respective article decreased. These results indicate that increasing processing temperature may be correlated to densification and contraction of the PE article, condensing of the microstructure of the PE article, a decrease in pore size of the PE article, and/or a more monolithic structure. This also indicates that densification, condensing of the microstructure, decreased pore size, and an increased monolithic structure of the respective PE articles upon increasing processing temperature is not limited to just one type of porous ePE film, but may be observed with both the first and second porous ePE films.

Turning to FIG. 12, a peel strength was measured for each of the fourth, fifth, and sixth PE articles 806, 808, 810. The peel strength was measured as force to peel the article back about 12 mm and is shown in units of N/12 mm. As shown by the data, as processing temperature increased above the melt temperature, the peel strength of the respective article was increased. In other words, a force required to pull the third PE article 804 is larger than a force required to pull the second PE article 802, and the force required to pull the second PE article 802 is larger than a force required to pull the first PE article 800. The increase in force may also be correlated to densification and compaction of the PE article and/or condensing of the microstructure of the PE article. The increased force needed to pull back the article indicates that the layers or space within the PE article is decreased as the processing temperature increases, and new bonds may be made within the PE article. The increase in pull force also indicates that the PE article becomes more monolithic as processing temperatures increase because layers within the article may become less defined and more difficult to separate.

Though the above example was described with respect to tubular PE articles, flat PE articles, or other shapes of PE articles, may show similar behavior, and similar material property changes, upon being heated to a temperature above the melt.

Although specific embodiments are provided herein, it is understood that different arrangements and material properties may be selected and be treated in the spirit of this disclosure. Furthermore, the specific embodiments provide temperatures, steps, and properties that may be modified while still being within the spirit of this disclosure.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. A method of forming a polyethylene (PE) article, comprising:
assembling a plurality of polyethylene substrates onto a first support, the plurality of polyethylene substrates defining a PE construct;
applying a second support to the PE construct such that the PE construct is positioned between the first support and the second support;
positioning the first support, the PE construct, and the second support proximate a housing; and
applying a force to the first support, the second support, and the PE construct such that the first support, the second support, and the PE construct expand to conform to the housing,
wherein the housing limits distension of the first support, the second support, and the PE construct beyond the housing such that when the PE construct expands, an PE article is formed.

2. The method of claim 1, wherein applying the force to the PE construct results in a monolithic PE article.

3. The method of claim 2, wherein the monolithic PE article is seamless.

4. The method of claim 1, further including positioning the first support, the second support, and the PE construct about a mandrel.

5. The method of claim 3, wherein the mandrel is porous or perforated.

6. The method of claim 1, wherein the first support and the second support are formed of silicone.

7. The method of claim 1, wherein assembling the plurality of polyethylene components further includes assembling other components formed of materials other than PE including at least one of expanded polyethylene, polytetrafluoroethylene or expanded polytetrafluoroethylene.

8. The method of claim 1, further including heating the PE construct.

9. The method of claim 1, wherein applying the force to the first support, the second support, and the PE construct includes heating liquid positioned within a mandrel to about 130 degrees Celsius such that the liquid phase transitions to gas which applies the force.

10. The method of claim 8, wherein heating the liquid to gas results in a liquid to gas expansion ratio of about 1:1600.

11. The method of claim 1, wherein applying the force to the first support, the second support, and the PE construct includes releasing compressed gasses.

12. A method of forming a monolithic polyethylene (PE) article, comprising:
positioning a PE construct such that a first portion of the PE construct overlaps with a second portion of the PE construct;
applying heat to the PE construct; and
expanding the PE construct simultaneous with applying heat to the PE construct.

13. The method of claim 12, wherein positioning the PE construct includes positioning the PE construct between a first silicone support and a second silicone support.

14. The method of claim 13, wherein expanding the PE construct includes applying a force to one of the first silicone support and the second silicone support such that the first silicone support, the PE construct, and the second silicone support expand together.

15. The method of claim 14, wherein expanding the PE construct includes applying the force via pressure.

16. The method of claim 15, wherein the pressure is provided via heated liquid transitioning to gas.

17. The method of claim 15, wherein the pressure is provided via compressed gasses.

18. The method of claim 14, wherein expanding the PE construct simultaneously with applying heat forms a seamless monolithic PE article.

19. A method of forming a polyethylene (PE) article, comprising:
assembling a PE construct onto a first shaped support;
positioning a punch proximate the PE construct;
applying a force to the PE construct via the punch such that the punch contacts the PE construct and pushes the PE construct into the first shaped support, the PE construct conforming to a shape of the first shaped support;
applying heat to the PE construct; and
releasing the punch from the PE construct to form the PE article, the PE article retaining the shape of the first shaped support.

20. The method of claim 19, wherein applying heat to the PE construct is includes applying heat of about 130 degrees Celsius.

21. The method of claim 19, wherein applying heat to the PE construct densifies the PE article, the density being a gradient across the PE article.

22. The method of claim 19, wherein applying a force to the punch and applying heat to the PE construct are done simultaneously.

23. The method of claim 19, wherein applying heat to the PE construct is done while the PE construct is within the first shaped support.
